(19) United States
(12) Patent Application Publication
(10) Pub. No.: US 2022/0357479 A1
(43) Pub. Date: Nov. 10, 2022

(54) Method and Apparatus for Fracture Width Measurement

(71) Applicant: Quidnet Energy Inc., Houston, TX (US)

(72) Inventors: Bunker Hill, Sugar Land, TX (US); Ken Havlinek, Houston, TX (US)

(73) Assignee: Quidnet Energy Inc., Houston, TX (US)

(21) Appl. No.: 17/741,369

(22) Filed: May 10, 2022

Related U.S. Application Data
(60) Provisional application No. 63/186,678, filed on May 10, 2021.

(51) Int. Cl. G01V 99/00; G01B 7/02

(52) U.S. Cl. CPC G01V 99/005; G01B 7/02; G01V 2210/646

(57) ABSTRACT

A wireline width measuring apparatus and associated method which may be used to measure static and dynamic fracture width in fractures used for energy storage, water injection, or hydrocarbon production. In one embodiment, the method comprises determining a depth of the formation fracture, determining the depth of the bottom of the wellbore, positioning a caliper tool string comprising a caliper apparatus at the bottom of the wellbore, wherein the caliper apparatus is positioned at a depth capable of measuring movement of a window cut into a casing of the wellbore at the depth of the formation fracture, inflating the fracture by injecting a fluid into the fracture, uninflating the fracture by producing the fluid from the fracture, and measuring movement of the window cut into the wellbore while the fracture is inflated and uninflated.

### CROSS-REFERENCE TO RELATED APPLICATIONS

This application is a non-provisional application that claims the benefit of U.S. Provisional Application No. 63/186,678 filed on May 10, 2021, the disclosure of which is incorporated by reference herein in its entirety.

### STATEMENT REGARDING FEDERALLY SPONSORED RESEARCH OR DEVELOPMENT

Not applicable.

### BACKGROUND OF THE INVENTION

### Field of the Invention

The present invention pertains to a method and apparatus for measuring formation fracture width under static and dynamic conditions.

### Background of the Invention

Fractures have been created in underground geologic formations for many years and many purposes. The initiation, propagation, and propping of these fractures has been widely studied and modeled in both the industry and academia. Largely, however, these fractures propagate vertically throughout the formations, and the vast majority of the literature and measurement techniques are devoted to vertical fractures. Horizontally initiated fractures are used in mining and for the storage of energy. The performance of these fractures is largely dependent on the fracture “width”. The width of a horizontal fracture can vary widely, and measuring this width under dynamic conditions is essential for understanding the static and dynamic performance of the fracture.

Present technologies available for measuring fracture width include an SIMFIP probe, which was developed to measure very small changes in fracture width for largely vertical fractures of well bores. The SIMFIP probe functions as a system of strain gauges to measure relative motion in all directions within a downhole environment. As it is composed of strain gauges, it can only measure relatively small displacements, where it has been successful at capturing those small displacements in a downhole environment. Unfortunately, this device has a very limited range of motion, and cannot be applied to a dynamically responding horizontal fracture. Freepoint measuring tools are designed to measure strain in tubing, casing, and drilling strings. These strain gauge-based measurement devices cannot respond to the large changes in width of a horizontal fracture. Downhole cameras have also been attempted to be used to view and measure fracture width. Unfortunately, image quality and optical clarity of flowing fluids are not of sufficient quality to quantitatively measure dynamic fracture motions.

Consequently, there is a need for an apparatus and method capable of measuring fracture width under static and dynamic conditions commonly encountered in fractures utilized for the storage of energy, water injection, and hydrocarbon production.

### BRIEF SUMMARY OF SOME OF THE PREFERRED EMBODIMENTS

These and other needs in the art are addressed in one embodiment by a wireline width measuring apparatus and associated method which may be used to gauge static and dynamic fracture width in hydraulic fractures with a horizontal component. The wireline width measuring apparatus provides the ability to monitor the real time fracture width while injecting and flowing from the horizontal fracture. This device consists of a wireline caliper tool resting on a plug positioned below the fracture, while the caliper arms are engaged with the borehole just above the fracture opening. As the fracture moves, it is recorded as an apparent change in hole diameter that can then be mapped to vertical motion. The apparatus and method serve to measure the width of any fracture that intersects a wellbore over a reasonable length of wellbore. The apparatus measures width in real time, and functions while fluid is flowing to/from the fracture opening. Additionally, the method provides an inexpensive and robust methodology to measure fracture width in real time using commercial off-the-shelf wireline equipment, and does not need any special electronics or hardware. Instead, the method leverages the capabilities of existing technologies used in a unique configuration and process.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims. Additionally, in the following disclosure of the representative embodiments of the invention, including the claims, directional terms, such as “above,” “upper,” “upward” and similar terms refer to a direction towards the earth's surface along a wellbore, and “below,” “lower,” “downward” and similar terms refer to a direction away from the earth's surface along the wellbore.

### BRIEF DESCRIPTION OF THE DRAWINGS

For a detailed description of the preferred embodiments of the invention, reference will now be made to the accompanying drawings in which:

FIG. 1 illustrates an embodiment of a caliper tool string with dual centralizers and a spacer;

FIG. 2A illustrates an embodiment of an uninflated horizontally initiated fracture;

FIG. 2B illustrates an embodiment of an inflated horizontally initiated fracture; and

FIG. 3 illustrates an embodiment of a caliper tool string disposed in a wellbore.

### DETAILED DESCRIPTION OF THE PREFERRED EMBODIMENTS

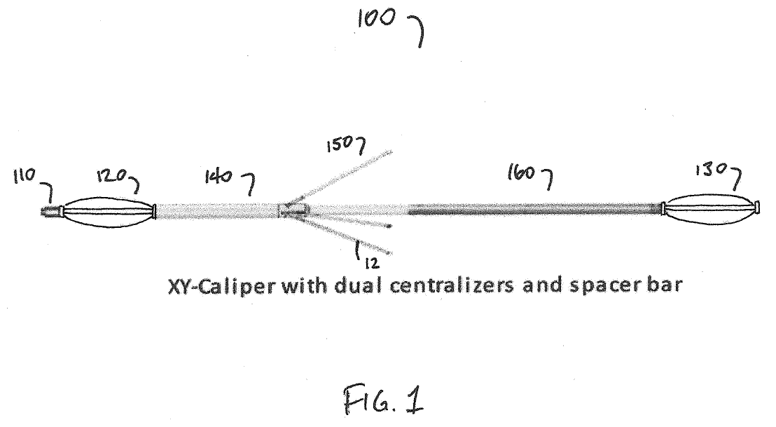

Referring to FIG. 1, an embodiment of a caliper apparatus 150 is shown as a component of caliper tool string 100 which further comprises wireline connection component 110, dual centralizers 120, 130, caliper electronics module 140 and spacer 160. In embodiments, caliper tool string 100 may minimally comprise caliper electronics module 140 and XY caliper apparatus 150, while in alternate embodiments, caliper tool string 100 may comprise additional components in addition to those illustrated in FIG. 1, for example one or more weights may be added to caliper tool string 100.

Wireline connection component 110 may comprise any wireline connection device known in the art which may be suitable for connecting caliper tool string 100 to a wireline. Similarly, centralizers 120, 130 may comprise any centralizer device known in the art which may be suitable for use in caliper tool string 100. In embodiments, centralizers 120, 130 may be adjustable bow spring centralizers, which may be configurable to individually adjust relative friction between a wellbore casing 10 and centralizer 120, and between the wellbore casing 10 and centralizer 130.

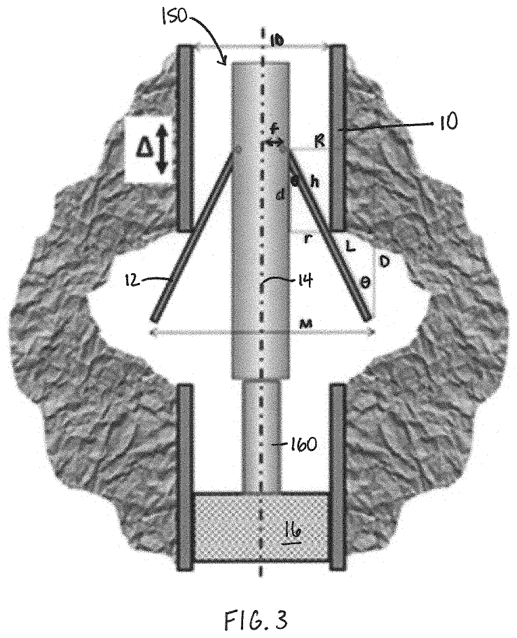

Caliper electronics module 140 and caliper apparatus 150 may act in unison to provide surface measurements of diameter M as illustrated in FIG. 3. In embodiments, caliper apparatus 150 may comprise one or more arms 12 which extend away from the centerline 14 of caliper apparatus 150. In embodiments, the one or more arms 12 may be utilized to measure a diameter of a wellbore casing 10 within which caliper apparatus 150 may be disposed. Caliper apparatus 150 may communicate with caliper electronics module 140 through known means, such that caliper electronics module 140 may be able to compute diameter M based on the angular positioning of the one or more arms 12 of caliper apparatus 150. In embodiments, caliper electronics module 140 may be configured to record diameter M, or changes thereto, or may be configured to communicate diameter M, or changes thereto to surface equipment associated with the wellbore. Caliper electronics module 140 and caliper apparatus 150 may be any diameter suitable for use in cased or open-hole well operations. For example, caliper electronics module 140 or caliper apparatus 150 may be less than 3 inches in diameter. Caliper apparatus 150 may enable measurements of diameter M between 2 and 28 inches. Caliper electronics module 140 and caliper apparatus 150 may be formed from any material or materials suitable for use in cased or open-hole wellbore operations.

Spacer 160 allows caliper apparatus 150 to be positioned at a fracture window when caliper tool string 100 is disposed in an operational position at the bottom of a wellbore. Spacer 160 may be any suitable length allowing caliper apparatus 150 to be positioned at the fracture window. For example, spacer 160 may be a length wherein a caliper tool string 100 comprising spacer 160 may be 8 feet in length to greater than 60 feet in length. In embodiments, caliper tool string comprising spacer 160 may be between 8 and 30 feet in length, between 20 and 40 feet in length, between 30 and 50 feet in length, or between 40 and 60 feet in length.

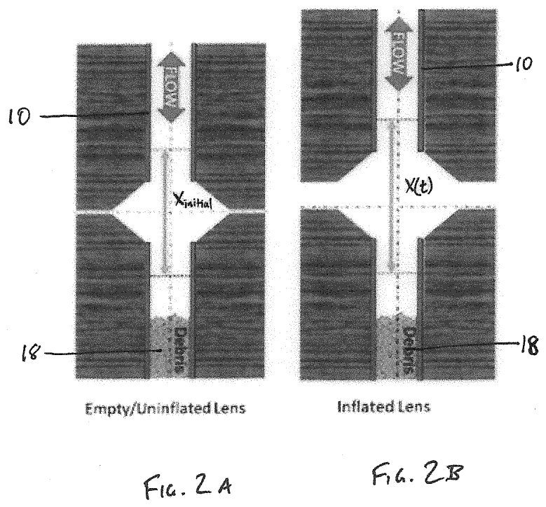

FIGS. 2A and 2B, illustrate embodiments of a horizontally initiated fracture lens, with FIG. 2A illustrating such a lens in an uninflated state and FIG. 2B illustrating such a lens in an inflated state. Utilization of horizontally initiated fracture lenses for storage of energy often comprises injecting fluid into a hydraulic fracture in the earth and producing the fluid from the fracture while recovering power through associated generation techniques, as described by U.S. Pat. No. 8,763,387, the entire contents of which are incorporated herein by reference thereto. Typically, fracture “windows” may be cut into wellbore casing 10 at a desired depth in a formation, wherein the cutting may remove a length of casing 10 and cut into the surrounding formation. Typically, cutting the fracture window may result in debris 18 settling below the window at the bottom of the wellbore. Debris 18 may also be produced when fluid is withdrawn from the fracture. Under typical operational conditions, fluid direction may modulate depending upon whether the fluid is being injected into the fracture or produced from the fracture, and accordingly the width of the fracture may expand while the fracture is inflated, or contract as the fluid is being produced while the fracture returns to an uninflated state, respectively. As show in FIG. 2A, an uninflated fracture may have an initial width that may be measured and represented as Xᵢₙᵢₜᵢₐₗ, while an inflated fracture may have a width that changes over time and may be measured and represented as X(t). Measuring the variations in the width of the fracture under dynamic conditions is essential for understanding the static and dynamic performance of the fracture.

FIG. 3 illustrates caliper tool string 100 comprising caliper apparatus 150 disposed in an operational position in a wellbore. As illustrated, caliper tool string 100 is in resting contact with the upper surface of a plug 16 set at the bottom of the wellbore, and the depth of caliper apparatus 150 is set such that a central location of its one or more arms 12 are positioned in slidable contact with the edge of the casing 10 at the top of the fracture window. In operation, as the fracture inflates and uninflates, the one or more arms 12 of caliper apparatus 150 will slide against the edge of the upper casing 10 as the upper casing 10 raises and lowers with the inflation or uninflation of the fracture, causing caliper apparatus 150 to measure apparent diameter M. From the known measurements of apparent diameter M and arm length L, arm angle θ may be determined, which may allow subsequent determination of depth d through known mathematical and trigonometric calculations, thus providing a measure of vertical expansion or contraction of fracture width X(t). Table 1 below provides descriptions of the variables used in FIG. 3 as well as corresponding calculations and example values of conversion from caliper apparatus out (M) to vertical distance (d) and delta (Δ):

TABLE 1

| Variable | Description | Calculation | Values |
|---|---|---|---|
| L | Length of Arm | Input | 16.750 in |
| | (Pin to tip) | | |
| ID | Casing Internal | Input | 6.276 in |
| | Diameter | | |
| ƒ | Offset from arm | Input | 0.750 in |
| | pin to tool axis | | |
| r | Horizontal | r = ID/2 − f | 2.388 in |
| | Distance from | | |
| | pin to casing ID | | |
| M | Caliper Arm | Input | 12.762 in |
| | Output (inches) | | |
| R | Horizontal | R = M/2 − f | 5.631 in |
| | Extension | | |
| | (arm pin to tip) | | |
| θ | Angle between | θ = sin⁻¹ (R/L) | 19.64 deg |
| | arm and tool axis | | |
| D | Vertical Distance | D = R/Tan (θ) | 15.775 in |
| | (arm pin to tip) | | |
| d | Vertical Distance | d = r/Tan (θ) | 6.690 |
| | (arm pin to | | |
| | casing end) | | |
| dᵢₙᵢₜᵢₐₗ | Starting Distance | Input | 6.690 |
| Δ | Vertical Motion | Δ = dᵢₙᵢₜᵢₐₗ − d | 0 |
| | from start of phase | | |

In combination, caliper tool string 100, comprising caliper apparatus 150, and the computational procedures just described enable a method of measuring static and dynamic performance of a fracture used for energy storage.

The method begins by first running caliper tool string 100 into the wellbore to identify the depth of the bottom of the wellbore and the depths of a window cut into the casing 10 at the desired depth of a fracture. To measure these depths, caliper tool string 100 may be run into the wellbore through known wireline operations until caliper tool string 100 touches the bottom of the wellbore, which may include debris 18 remaining from cutting the window in the casing 10 at the surrounding formation. Caliper tool string 100 may then be raised until the one or more arms 12 of the caliper apparatus 150 register the bottom of the fracture window, which may be identified when the caliper apparatus 150 registers an increase in the diameter M measured by its one or more arms 12, wherein the arms 12 are freed to extend to an extended position due to the opening in the casing 10 wall. Caliper tool string 100 may then be raised further until the one or more arms 12 begin to register a decrease in the diameter M, which will correspond to the arms 12 engaging the casing 10 opening at the top of the fracture window, wherein the arms 12 come into contact with the casing 10 causing the arms 12 to return to a retracted position.

From these known measurements of the fracture window and the wellbore bottom, which may or may not comprise debris 18, a desired location for a plug 16 to be positioned below the fracture window may be determined. Once desired location is determined, the plug 16 may be set at the desired location using known plug setting techniques and any suitable plug known in the art capable of providing a firmly seated upper surface. For example, the plug 16 may be a bridge plug or a composite fracture plug.

After the plug 16 has been set, caliper tool string 100 may be run into the wellbore until it comes to rest on the upper surface of the seated plug 16. Caliper tool string 100 may then be pulled slowly up-hole until the one or more arms 12 begin to register a decrease in the measured diameter M, indicating that they may be in contact with the casing 10 at the top of the fracture window, and the depth at which the decrease in the measured diameter M is recorded. Based upon this measured depth, a desired length for spacer 160 may be determined, which may position the caliper apparatus 150 such that its one or more arms 12 may be positioned in slidable contact with the casing 10 edge at the top of the fracture window and also allow the arms 12 to remain in contact with the casing 10 edge while the fracture is inflated and uninflated during operational injection or production cycles.

Once the desired length of spacer 160 has been determined, caliper tool string 100 may be returned to the surface, spacer 160 may be sized to the desired length, and caliper tool string 100 assembled to include spacer 160 disposed between caliper apparatus 150 and centralizer 130. At this time weights may be added to caliper tool string 100, and centralizers 120, 130 may be adjusted such that when caliper tool string 100 is disposed at a position wherein it is in resting contact with the seated plug 16 at the wellbore bottom, the friction between the wellbore casing 10 and centralizer 120 may be decreased, and the friction between the wellbore casing 10 and centralizer 130 may be increased. These weights and/or adjustments in relative friction between the two centralizers may assist caliper tool string 100 to remain in resting contact with the seated plug 16 at the wellbore bottom, while the one or more arms 12 of caliper apparatus 150 remain in slidable contact with the casing 10 edge at the top of the fracture window as the fracture modulates between inflated and uninflated states.

Once assembled, caliper tool string 100 may be run down-hole until caliper tool string 100 is disposed at a depth wherein it is in resting contact with the set bridge plug 16 at the wellbore bottom. Once in position, the tension in the wireline is reduced, setting the slack tension to zero, such that caliper tool string 100 rests on the set plug 16's upper surface under the force of gravity acting on its own weight. In this operational position, any increases in the friction between the wellbore casing 10 and centralizer 130 may assist caliper tool string to remain in resting contact with the upper surface of the set plug 16 at the wellbore bottom. In this position, caliper tool string 100 is now readied for operation.

In operation, caliper tool string 100 remains in resting contact with the upper surface of the set plug 16 at the wellbore bottom, while the one or more arms 12 of caliper apparatus 150 register changes in apparent diameter M of the wellbore casing 10 as the fracture is inflated or uninflated as a result of fluid being injected into or produced from the fracture. These changes in apparent diameter M result from increases or decreases in the angle 9 between the one or more arms 12 and the centerline 14 of caliper apparatus 150 while the edge of the wellbore casing 10 at the top of the fracture window slides along and/or against the one or more arms 12 of caliper apparatus 150. As illustrated in FIG. 3, where the apparent diameter M and angle θ are known, it is possible to translate these measurements into a measure of vertical expansion or contraction of fracture width X(t) as illustrated in FIG. 2B. In embodiments, caliper apparatus 150 may provide real-time measurement and feedback of 1-100 Hz cycles, may be accurate to better than 0.01 inches travel in measurement resolution, and may provide 0 to 12 inches in operational stroke.

Although the present invention and its advantages have been described in detail, it should be understood that various changes, substitutions and alterations may be made herein without departing from the spirit and scope of the invention as defined by the appended claims.

What is claimed is:

1. An apparatus for measuring static and dynamic fracture width of a horizontal fracture in a wellbore comprising:
a caliper apparatus comprising a body and one or more retractable arms that are angularly positioned to laterally extend away from a centerline of the body via abduction and laterally retract toward the centerline of the body via adduction;
a caliper electronics module that is in communication with the caliper apparatus and computes the static and dynamic fracture width of the horizontal fracture over time based on the angular positioning of the one or more arms; and
a wireline connection component that connects the apparatus to a wireline.

2. The apparatus of claim 1, further comprising one or more centralizers that individually adjust relative friction between the wellbore and the one or more centralizers.

3. The apparatus of claim 2, wherein the one or more centralizers are bow spring centralizers.

4. The apparatus of claim 2, wherein the one or more centralizers comprise a first centralizer disposed above the caliper apparatus and the caliper electronics module, and a second centralizer disposed below the caliper apparatus and the caliper electronics module.

5. The apparatus of claim 1, further comprising a spacer that facilitates positioning of the caliper apparatus at a fracture window.

6. The apparatus of claim 5, wherein size of the spacer is variable and dependent on a desired positioning of the caliper apparatus as it relates to the fracture window.

7. The apparatus of claim 5, wherein the spacer is disposed below the caliper apparatus and the caliper electronics module.

8. The apparatus of claim 1, further comprising one or more weights that aids in maintaining positioning of the caliper apparatus.

9. A method for measuring static and dynamic fracture width of a horizontal fracture in a wellbore comprising:
(A) running a caliper tool string down to a bottom of the wellbore via a wireline operation to determine depth of the bottom of the wellbore, wherein the caliper tool string comprises:
a caliper apparatus comprising a body and one or more retractable arms that are angularly positioned to laterally extend away from a centerline of the body via abduction and laterally retract toward the centerline of the body via adduction;
a caliper electronics module that is in communication with the caliper apparatus and computes the static and dynamic fracture width of the horizontal fracture over time based on the angular positioning of the one or more arms; and
a wireline connection component that connects the apparatus to a wireline;
(B) raising the caliper tool string up from the bottom of the wellbore via wireline operations until the caliper apparatus and the caliper electronics module register an increase and subsequent decrease in diameter of the one or more retractable arms, thereby obtaining fracture window depth measurements of a fracture window;
(C) removing the caliper tool string from the wellbore via wireline operations;
(D) determining an optimal location for a plug to be positioned within the wellbore below the fracture window based on the fracture window depth measurements and setting the plug at the optimal position via plug setting techniques, thereby providing a set plug within the wellbore;
(E) running the caliper tool string down the wellbore via wireline operations until the caliper tool string rests on an upper surface of the set plug;
(F) raising the caliper tool string up from the upper surface of the set plug via wireline operations until the caliper apparatus and the caliper electronics module register a decrease in diameter of the one or more retractable arms, thereby obtaining additional fracture window depth measurements of the fracture window;
(G) removing the caliper tool string from the wellbore via wireline operations for a second time;
(H) determining an optimal length for a spacer to be installed on the caliper tool string based on the additional fracture window depth measurements and installing the spacer of the optimal length onto the caliper tool string;
(I) running the caliper tool string with the spacer down the wellbore via wireline operations until the caliper tool string rests on the upper surface of the set plug, wherein the one or more retractable arms are positioned in slidable contact with a top of the fracture window; and
(J) monitoring the static and dynamic fracture width computed via the caliper apparatus and the caliper electronic module based on the angular movement of the one or more retractable arms as the horizontal fracture is inflated and deflated.

10. The method of claim 9, wherein the bottom of the wellbore is a point at which accumulated debris disposed in the wellbore begins.

11. The method of claim 10, wherein the accumulated debris comprises debris from fracture window cutting operations.

12. The method of claim 9, wherein the increase in diameter of the one or more retractable arms identifies a bottom of the fracture window.

13. The method of claim 9, wherein the decrease in diameter of the one or more retractable arms corresponds to an engagement of the one or more retractable arms with a casing opening at the top of the fracture window.

14. The method of claim 9, wherein the optimal location for the plug allows the one or more arms of the caliper apparatus to be extended when resting on the upper surface of the set plug.

15. The method of claim 9, wherein the plug is a bridge plug or a composite fracture plug.

16. The method of claim 9, wherein the horizontal fracture is inflated and deflated during operational injections or production cycles.

17. The method of claim 9, further comprising installing one or more weights to the caliper tool string to aid in maintaining its resting position on the upper surface of the set plug.

18. The method of claim 9, wherein the caliper tool string further comprises one or more centralizers that individually adjust relative friction between the wellbore and the one or more centralizers.

19. The method of claim 18, wherein the one or more centralizers comprise a first centralizer disposed above the caliper apparatus and the caliper electronics module, and a second centralizer disposed below the caliper apparatus and the caliper electronics module.

20. The method of claim 19, wherein the relative friction between the wellbore and the first centralizer is decreased and the relative friction between the wellbore and the second centralizer is increased when the caliper tool string is resting on the upper surface of the set plug at step (J).
